(19) United States
(12) Patent Application Publication
(10) Pub. No.: US 2022/0118548 A1
(43) Pub. Date: Apr. 21, 2022

(54) METHOD AND PROCESSING MACHINE FOR PORE DEFECT MONITORING OF A LASER WELDING PROCESS FOR WELDING A PLURALITY OF BAR CONDUCTORS AND ASSOCIATED COMPUTER PROGRAM PRODUCT

(71) Applicant: TRUMPF Laser- und Systemtechnik GmbH, Ditzingen (DE)

(72) Inventors: Nicolai Speker, Pleidelsheim (DE); Oliver Bocksrocker, Sachsenheim (DE)

(21) Appl. No.: 17/503,546

(22) Filed: Oct. 18, 2021

(30) Foreign Application Priority Data
Oct. 16, 2020 (DE) 10 2020 213 109.0

(51) Int. Cl. B23K 26/03; B23K 26/22; B23K 26/06

(52) U.S. Cl. CPC B23K 26/032; B23K 2103/12; B23K 26/0648; B23K 26/22

(57) ABSTRACT

A method is provided for monitoring a laser welding process for welding two workpieces of metallic material, particularly copper or aluminum, preferably bar conductors, by using a laser beam, particularly for monitoring a plurality of identical laser welding processes for welding two identical workpieces with the same laser power and the same welding duration of the laser beam. During the welding, the laser beam is directed onto adjacently disposed end faces of the workpieces to melt a fusion spot at the end faces then solidifying to form a weld bead. During the welding, the solidification duration from turning off the laser beam until solidification of the fusion spot is determined, the determined solidification duration is compared with a setpoint solidification duration predetermined for pore defect-free welding, and if the determined solidification duration falls below the predetermined setpoint solidification duration, the solidified weld bead is classified as defective.

### CROSS-REFERENCE TO RELATED APPLICATION

This application claims the priority, under 35 U.S.C. § 119, of German Patent Application DE 10 2020 213 109.0, filed Oct. 16, 2020; the prior application is herewith incorporated by reference in its entirety.

### FIELD AND BACKGROUND OF THE INVENTION

The present invention relates to a method for monitoring a laser welding process for welding two workpieces made of metallic material, in particular copper or aluminum, preferably bar conductors, by using a laser beam, in particular for monitoring a plurality of identical laser welding processes for welding two identical workpieces with the same laser power and the same welding duration of the laser beam, wherein during the welding of the two workpieces, the laser beam is directed onto adjacently disposed end faces of the workpieces in order to melt a fusion spot at the two end faces which then solidifies to form a weld bead. Preferably, the end faces of the workpieces, onto which the processing laser beam is directed, are respectively disposed adjacently at the same height. The invention also relates to a processing machine suitable for carrying out the method and to an associated computer program product.

One typical error in laser welding is the formation of pores, which reduce the function of the welding. In general, it is not possible to ascertain externally whether pores have been formed in a weld seam or bead. Only by destructive testing or by computed tomography (CT) or X-ray technology is it possible to test subsequently whether defective connections have been formed. In the general case, visual inspection is therefore carried out by the worker or random samples are cyclically evaluated by CT or X-ray technology.

Copper-containing bent bar conductors, in particular so-called hairpins, are installed in electrodynamic machines such as electric motors or electrical generators. The bar conductors are disposed and welded to one another according to an intended electrical layout, so as to construct an electromagnet. An electric motor in this case typically includes several dozen, often hundreds of bent bar conductors, which need to be welded to one another in pairs. In this case, by using the welding it is important to provide a sufficient cross-sectional area (“connecting area”), through which the electrical current can flow from one bar conductor into the other bar conductor. If the connecting area is too small, there is a risk of significant ohmic heating, a loss of efficiency or even unusability of the electrodynamic machine.

The welding of the bar conductors is carried out by using a laser beam, which for that purpose is typically directed onto the outer end faces of two adjacently disposed bar conductors, which usually bear on one another. The end faces are melted by the heat introduced and, after solidification, are connected to one another by using a resolidified weld bead. In general, the laser beam is always directed onto the bar conductors with the same power and for the same time, so that a sufficiently large connecting area is achieved.

Because of contamination or roughness on the surface of the bar conductors, however, the reflectivity of the bar conductors for the laser beam, and therefore also the actual energy input, may vary. Likewise, the actual energy input may vary because of positioning errors of the bar conductors, for example gaps or an offset, or because of inaccurate positioning of the laser beam. In the event of insufficient energy input, too little material is melted so that a weld bead that is too small, which provides an insufficient connecting area, is formed. A weld bead that is too small, with an insufficient connecting area, may also occur in the case of significant spattering during welding.

Especially in the welding of bar conductors having several hundred welds on only a single component (motor stator), the welding defect that occurs because of pore formation is problematic in its statistical entirety. In particular, large pores that permanently interfere with the function of the current flow in bar conductors occur mostly when sizeable amounts of melt are ejected from the process zone in the form of spatters. Because of the large number of welds on only a single component, neither visual inspection nor the evaluation of random samples offers sufficient reliability for production with a low reject rate. With an accepted function reject rate of for example 1/100,000 for a stator with 500 welds, for example, only one weld out of 50 million can be defective. 100% inspection and monitoring of the welding processes are indispensable for that purpose.

For example, German Patent DE 10 2004 016 669 B3, corresponding to U.S. Pat. No. 7,620,233, discloses a method for testing a weld seam that is introduced into one or more workpieces by using laser beam welding. In that case, characteristic signals from the region of the weld seam are received by using a sensor and are compared with setpoint values, with only those signals that are received in a characteristic time interval after the laser beam welding, which starts at the earliest after hardening of the weld seam, being taken into account.

### SUMMARY OF THE INVENTION

It is accordingly an object of the invention to provide a method and a processing machine for pore defect monitoring of a laser welding process for welding a plurality of bar conductors and an associated computer program product, which overcome the hereinafore-mentioned disadvantages of the heretofore-known methods, machines and computer program products of this general type and which provide a method for monitoring a laser welding process, in particular a plurality of identical laser welding processes for welding two workpieces, which may be carried out simply, rapidly and nondestructively.

With the foregoing and other objects in view there is provided, in accordance with the invention, a monitoring method as mentioned in the introduction, in which this object is achieved in that during the welding of two workpieces, the solidification duration from turning off the laser beam until solidification of the fusion spot is determined, the solidification duration determined is compared with a setpoint solidification duration predetermined for pore defect-free welding, and if the solidification duration determined falls below the predetermined setpoint solidification duration, the solidified weld bead is classified as defective (“pore defects present”).

The welding duration for a given end face cross section of two bar conductors to be connected is dependent on the available or selected welding power. If the bar cross section and the welding power are defined, this gives a defined melt volume in the case of pore defect-free welding. Since in practice the action time of the laser, i.e. the welding time, is no longer varied during repeated welding, all welding instances have the same temporal duration. A precision of a few ms is achieved in this case, which corresponds to a temporal deviation of typically <1%. This procedure ensures that the energy content of all of the welds is the same. Since the mass and the end face cross section of the bar conductors to be connected are likewise subject only to minor variation, a reproducible behavior is obtained during the cooling of the molten welding zone, always with the same solidification duration, starting after turning off the laser.

If melt is expelled from the fusion zone during the welding, the expelled melt has the effect on the cooling process that an energy loss of the welding zone also occurs together with the mass loss. In particular, large pores that permanently interfere with the function of the current flow in bar conductors occur mostly when sizeable amounts of melt are ejected from the process zone in the form of spatters. Less energy of the welding zone consequently flows into the heat sink of the bar conductors during the solidification, so that the solidification temperature is reached in a shorter time. According to the invention, the solidification duration starting after turning off the laser is evaluated and the qualitative state of the weld (pore defects present/pore defects not present or only insubstantially present) is inferred in the event of a behavior deviating from the setpoint solidification profile.

Particularly preferably, starting from turning off the laser beam, locally resolved digital images of the fusion spot are recorded continuously by using a detector, in particular a camera, and intensity-scale pixel images, in particular grayscale pixel images, are generated from the locally resolved detector images. The information concerning whether the melt or the fusion spot is still in the liquid state is contained in the scale of the intensity or gray values of the individual images. With a temperature of the fusion spot decreasing more greatly, the gray value changes from light to dark. Preferably, the images are respectively evaluated in an image section, particularly in an annular image section around the midpoint of the fusion spot.

In one preferred method variant, the intensity scale value averaged over all pixels of the pixel image is determined for each pixel image, and the solidification duration is determined with the aid of the temporal profile of the averaged intensity scale values. Preferably, the detector images are respectively evaluated only in an image section (region of interest (ROI)) of the recorded images. The fusion zone or spot is for example observed by the detector and, from the instant “laser OFF,” the development of the intensity values in a so-called region of interest (ROI) is evaluated. In time increments that correspond to the frame rate of the detector, an algorithm evaluates how long the cooling process lasts.

Preferably, the detector images are recorded as a process video with a recording frequency of at least 100 Hz, in particular at least 1 kHz.

For the case of a weld bead classified as defective (“pore defects present”), this weld bead is automatically rewelded or another action, in particular a warning message, is instigated, preferably depending on how much the solidification duration determined falls below the predetermined threshold value.

With the objects of the invention in view, there is also provided a processing machine for the laser welding of two workpieces made of metallic material, in particular copper or aluminum, preferably bar conductors, including a laser beam generator for generating a laser beam, processing optics for directing the laser beam onto mutually adjacently lying end faces of two workpieces in order to melt a fusion spot at the two end faces which then solidifies to form a weld bead, a locally resolving detector for locally resolved detection of the fusion spot, an image processing unit for evaluating the locally resolved detector images recorded by the detector in order to determine the solidification duration from turning off the laser beam until solidification of the fusion spot, and a pore defect monitoring device which monitors or classifies the solidified weld bead with respect to pore defects with the aid of the solidification duration determined. The detector is advantageously directed coaxially with the laser beam onto the end faces of the workpieces.

Preferably, the image processing unit includes an intensity-scale pixel image generating device for generating intensity-scale pixel images from the recorded detector images, and an evaluation device for evaluating the intensity-scale pixel images in order to determine the solidification duration from turning off the laser beam until solidification of the fusion spot.

With the objects of the invention in view, there is concomitantly provided a non-transitory computer program product which includes code configured to carry out all steps of the method according to the invention when the program runs on a machine controller of a processing machine.

Further advantages and advantageous configurations of the subject-matter of the invention may be found in the description, the drawings and the claims. Likewise, the features referred to above and those yet to be mentioned below may respectively be used independently or jointly in any desired combinations. The embodiments shown and described are not to be understood as an exhaustive list, but rather have an exemplary nature for the presentation of the invention.

Although the invention is illustrated and described herein as embodied in a method and a processing machine for pore defect monitoring of a laser welding process for welding a plurality of bar conductors and an associated computer program product, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic representation of a processing machine according to the invention for the laser welding of two bar conductors by using a laser beam;

FIGS. 2A-2C are images of a fusion spot generated on the end faces of the two bar conductors during the laser welding of two bar conductors directly after turning off the laser beam (FIG. 2A), during the solidification (FIG. 2A) and after the solidification (FIG. 2C);

FIG. 3 is an image of the liquid fusion spot with an annular image section around the midpoint of the fusion spot; and

FIGS. 4A and 4B are a temporal profile of the radiation intensity of the thermal radiation emitted by the fusion spot (FIG. 4A) and the temporal profile of the gray values of the images, respectively averaged over predetermined image pixels of the recorded images (FIG. 4B).

### DETAILED DESCRIPTION OF THE INVENTION

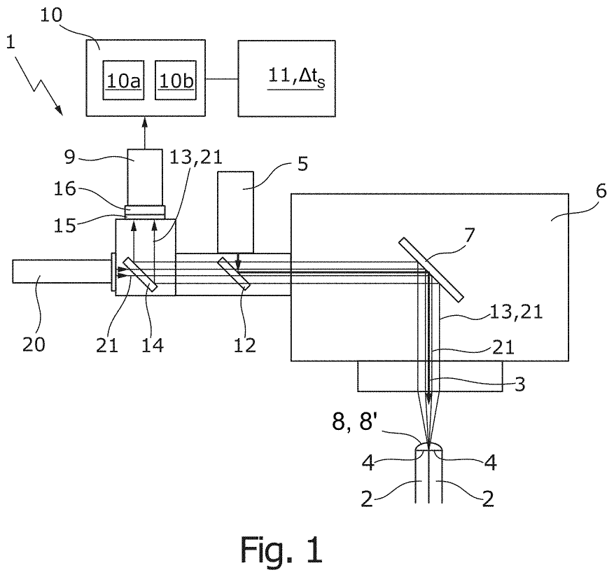

Referring now to the figures of the drawings in detail and first, particularly, to FIG. 1 thereof, there is seen a diagrammatically illustrated processing machine 1 used for the laser welding of two workpieces made of metallic material, in this case by way of example in the form of two bent bar conductors 2 (hairpins) made of copper, by using a laser beam 3. The two bar conductors 2 have the same end face 4 to be welded, with the same cross section, and are disposed adjacently, with their end faces 4 preferably at the same height.

The processing machine 1 includes a laser beam generator 5 for generating the laser beam 3, a processing head 6 with processing optics 7 for directing the laser beam 3 onto the end faces 4 of the two bar conductors 2 in order to melt a fusion spot or zone 8 on the end faces 4, a locally resolving detector directed onto the fusion spot 8, for example in the form of a camera 9, an image processing unit 10 for evaluating the digital images recorded in a locally resolved fashion by the camera 9, and a monitoring device 11 which monitors the fusion spot 8 solidified to form a weld bead 8′ with respect to pore formation with the aid of the evaluated camera images.

The laser beam 3 generated by the laser beam generator 5 strikes a beam splitter (for example in the form of a dichroic mirror) 12, which is reflective for the wavelength of the laser beam 3. Through the use of the beam splitter 12, the laser beam 3 is reflected through a focusing device not shown herein (for example a focusing lens) onto the processing optics 7, and is directed by the latter onto the two end faces 4. The processing optics 7 may, for example, be a laser scanner which has two mirrors respectively rotatable about mutually perpendicular axes, in order to deflect the laser beam 3 two-dimensionally.

Image beams 13 coming from the fusion spot 8, which travel through the processing optics 7, the beam splitter 12 which is transmissive for the image beams 13 and a further beam splitter (for example in the form of a dichroic mirror) 14, which is reflective for the image beams 13, to the camera 9 and form the image of the fusion spot 8 there, are registered by the camera 9. As shown, the camera 9 is aligned coaxially with the laser beam 3 by using the further beam splitter 14. An optical filter 15 and a collimation lens 16 for focusing the image beams 13 are optionally also disposed between the further beam splitter 14 and the camera 9. The optical filter 15 blocks the wavelength of the laser beam 3 so as to transmit only the process radiation coming from the fusion spot 8, but not the laser beam 3 reflected at the workpieces 2. The camera 9 may be configured to record individual images, or as a video camera for recording a video sequence, the recording frequency preferably being at least 100 Hz.

In order to monitor a laser welding process, in particular a plurality of identical laser welding processes respectively on two identical workpieces 2 with the same laser power and the same welding duration of the laser beam 3, the following procedure is adopted.

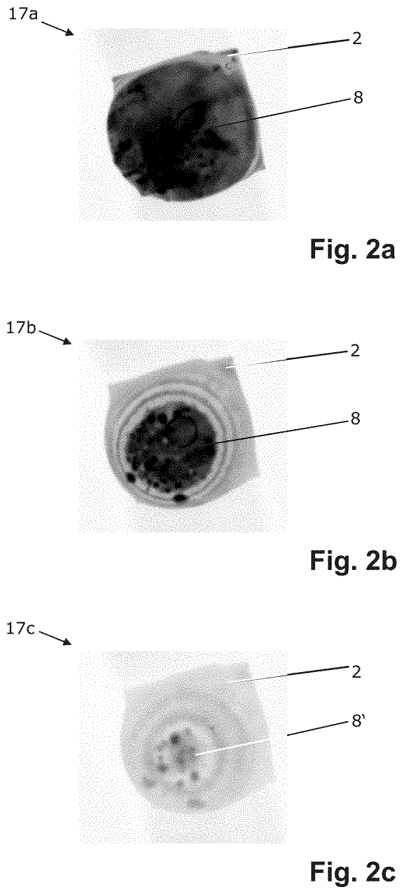

After the workpiece processing, i.e. beginning with turning off the laser beam 3, images 17a-17c of the fusion spot 8 are recorded continuously by the camera 9 (FIGS. 2A-2C), with the fusion spot 8 appearing light in the recorded images 17a-17c. The image 17a shows the liquid fusion spot 8 directly after turning off the laser beam 3 and before the solidification, the image 17b shows the liquid fusion spot 8 during the solidification and the image 17c shows the solidified weld bead 8′.

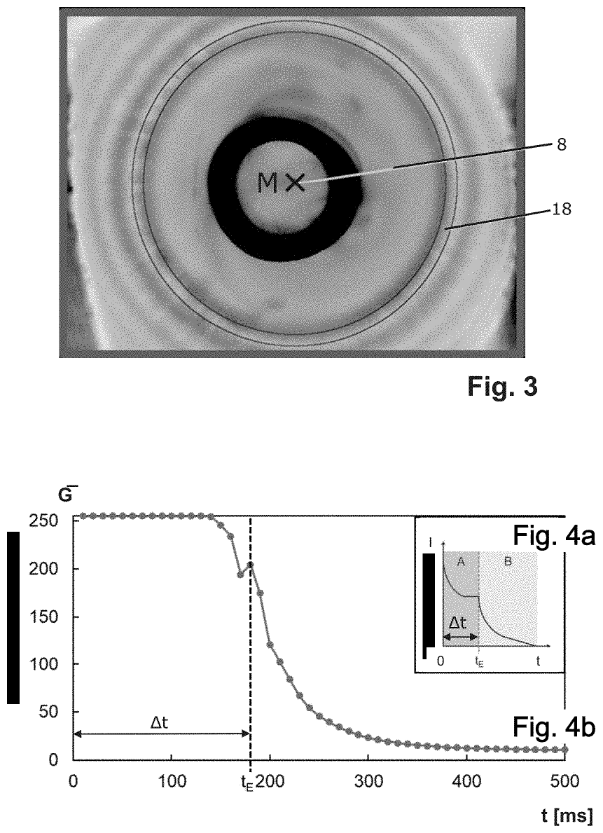

In a grayscale pixel image generating device 10a of the image processing apparatus 10, grayscale pixel images with pixel values between 0 (dark) and 255 (light) are respectively generated in an x-y pixel grid from the recorded images 17a-17c. With a temperature of the fusion spot 8 decreasing more greatly, the grayscale value changes from light to dark. In the pixel images, an identical image section (region of interest (ROI)) 18 is respectively defined by the image processing apparatus 10 (FIG. 3), for example in the form of an annular image section around the midpoint M of the fusion spot 8. In an evaluation device 10b of the image processing apparatus 10, the pixel images are evaluated in the ROI 18 in order to determine the solidification duration Δt from turning off the laser beam 3 until solidification of the fusion spot 8.

FIG. 4A shows the temporal profile of the radiation intensity I of the thermal radiation emitted by the fusion spot 8 after turning off the laser beam 3 at the instant t=0. The radiation intensity I decreases after turning off the laser beam 3 and remains at a plateau value from a few milliseconds before the solidification of the fusion spot 8 until the solidification (instant tE), before decreasing to zero.

After turning off the laser beam 3, the gray value profile is registered in a temporally resolved fashion inside the locally averaged ROI 18. For this purpose, by using the evaluation device 10b, the gray value G̅ averaged over all pixels of the ROI 18 is determined for each pixel image and the temporal profile shown in FIG. 4B of the averaged gray values G̅ is evaluated. With the aid of the characteristic temporal profile of the averaged gray values G̅, the instant tE of the solidification and therefore the solidification duration Δt may be determined clearly.

For repeated identical laser welding processes, in which the laser beam 3 always has the same laser power and the same welding duration, respectively on two identical bar conductors 2 with the same end faces 4 and the same bar cross section, in the case of pore defect-free welding, all welding instances have the same solidification duration Δt.

The solidification duration Δt determined in this way is compared in the monitoring device 11 with a setpoint solidification duration ΔtS predetermined for a pore defect-free weld bead 8′. If the solidification duration Δt determined falls below the predetermined threshold value ΔtS (Δt<ΔtS), the solidified weld bead 8′ is classified as defective (“pore defects present”). In the case of excessive deviations, automated rewelding may be initiated or any other desired action may be instigated.

In order to illuminate the fusion spot 8, the processing machine 1 may have an illumination laser 20, the illumination beam 21 of which is coupled through the two beam splitters 12, 14, which are transmissive for the wavelength of the illumination beam 21 in this direction, coaxially with the laser beam 3 into the processing head 6 and are directed onto the fusion spot 8. The illumination beam 21 reflected at the workpiece 2 travels on the reverse path back to the further beam splitter 14, which is reflective in this direction and deflects the illumination beam 21 onto the camera 9. In this case, the fusion spot 8 appears dark in the recorded images and illuminated solid material appears light.

1. A method for pore defect monitoring of a laser welding process for welding two workpieces or bar conductors made of metallic, copper or aluminum material by using a laser beam, or for monitoring a plurality of identical laser welding processes for welding two identical workpieces with the same laser power and the same welding duration of the laser beam, the method comprising:
during welding of two workpieces, directing the laser beam onto adjacently disposed end faces of the workpieces in order to melt a fusion spot at the two end faces then solidifying to form a weld bead;
during the welding of the two workpieces, determining a solidification duration from turning off the laser beam until solidification of the fusion spot;
comparing the determined solidification duration with a setpoint solidification duration predetermined for pore defect-free welding; and
classifying the solidified weld bead as defective upon the determined solidification duration falling below the predetermined setpoint solidification duration.

2. The method according to claim 1, which further comprises starting from turning off the laser beam, continuously recording locally resolved digital images of the fusion spot by using a detector or a camera, and generating intensity-scale pixel images or grayscale pixel images from the locally resolved detector images.

3. The method according to claim 2, which further comprises determining an intensity scale value averaged over all pixels of the pixel image or an established image section of the pixel image for each pixel image, and determining the solidification duration aided by a temporal profile of the averaged intensity scale values.

4. The method according to claim 2, which further comprises recording the detector images with a recording frequency of at least 100 Hz.

5. The method according to claim 2, which further comprises recording the detector images with a recording frequency of at least 1 kHz.

6. The method according to claim 2, which further comprises respectively evaluating the detector images in an image section or in an annular image section around a midpoint of the fusion spot.

7. The method according to claim 1, which further comprises upon classifying a weld bead as defective, automatically rewelding the weld bead or instigating another action or a warning message.

8. The method according to claim 7, which further comprises instigating the rewelding or the other action depending on how much the determined solidification duration deviates from the predetermined setpoint solidification duration.

9. A processing machine for laser welding two workpieces or bar conductors made of metallic, copper or aluminum material, the processing machine comprising:
a laser beam generator for generating a laser beam;
processing optics for directing the laser beam onto mutually adjacently lying end faces of the two workpieces in order to melt a fusion spot at the two end faces then solidifying to form a weld bead;
a locally resolving detector for locally resolved detection of the fusion spot and recording of locally resolved detector images;
an image processing unit for evaluating the locally resolved detector images recorded by said detector in order to determine a solidification duration from turning off the laser beam until solidification of the fusion spot; and
a pore defect monitoring device monitoring or classifying the solidified weld bead with respect to pore defects being aided by the determined solidification duration.

10. The processing machine according to claim 9, wherein said image processing unit includes:
an intensity-scale pixel image generating device for generating intensity-scale pixel images from the recorded detector images, and
an evaluation device for evaluating the intensity-scale pixel images in order to determine the solidification duration from turning off the laser beam until solidification of the fusion spot.

11. The processing machine according to claim 10, wherein said detector is disposed coaxially with the laser beam.

12. A non-transitory computer program product with instructions stored thereon, that carry out the steps of claim 1 when executed on a machine controller of a processing machine.
